(19) United States
(12) Patent Application Publication
(10) Pub. No.: US 2010/0186502 A1
(43) Pub. Date: Jul. 29, 2010

(54) METHOD AND WHEEL BALANCER FOR BALANCING A VEHICLE WHEEL

(76) Inventor: Francesco BRAGHIROLI, Reggio Emilia (IT)

Correspondence Address: MCDERMOTT WILL & EMERY LLP, 600 13TH STREET, N.W., WASHINGTON, DC, 20005-3096, US

(21) Appl. No.: 12/694,773

(22) Filed: Jan. 27, 2010

(30) Foreign Application Priority Data
Jan. 27, 2009 (EP) EP09001082.8-1236

(51) Int. Cl. G01M 1/02

(52) U.S. Cl. 73/459

(57) ABSTRACT

A method and a wheel balancer for balancing a vehicle wheel, comprising:
predetermining, dependent from the type of the vehicle wheel, axial positions for positioning at least a single correction weight on the wheel surface,
predetermining, dependent from the vehicle type, thresholds for the residual static and dynamic imbalances;
obtaining imbalance data for the vehicle wheel during a measuring run;
calculating from the imbalance data the respective mass and angular position of a correction weight each in one of the predetermined axial positions on the vehicle wheel;
comparing each of the predetermined static and dynamic residual imbalances with the achieved static and dynamic residual imbalances, when the calculated respective correction mass is placed by simulation in one of the axial position in the different angular positions; and
placing the single correction weight with the calculated mass in the calculated angular position in that axial position in which the residual imbalances are within the predetermined thresholds.

The invention concerns a method and a wheel balancer for balancing a vehicle wheel. Imbalance in the general case is a combination of static and dynamic (couple) imbalance. It is known to use at least two correction weights which are separated axially in correction planes on the wheel surface, particularly on the rim of the wheel to compensate the combination of static and dynamic imbalance within predetermined thresholds. To facilitate the operation work, two features are available in wheel balancer: the blind or suppression threshold and the rounding capability. The suppression (blind) threshold determines the amount of imbalance which can be neglected or the amount of the acceptable residual imbalance. The value of the suppression threshold is user—programmable and can be set within the range of 3.5-20 grams dependent from the desired degree of accuracy and from the vehicle type. The rounding capability rounds the measured imbalance for each correction plane to match commercially available sizes of correction weights.

U.S. Pat. No. 5,915,274 discloses a method for electronically determining at least one axial location for a correction weight from the scanned wheel profile and the measured imbalance data of the vehicle wheel to reduce the required number of correction planes to one when possible. In the known method, the balancer computer uses variable correction plane locations to present the best weight arrangement.

An object of the invention is to provide another method and another wheel balancer for balancing a wheel with a reduced amount of correction weight.

The object is solved by the features of claim 1. The subclaims disclose advantageous modifications of the invention.

The invention provides a method for balancing a vehicle wheel comprising the following steps. After the vehicle wheel has been mounted on a measurement shaft of the wheel balancer, axial locations along the wheel axis for correction planes within which at least a single correction weight has to be placed on the wheel surface are determined dependent from the type of the vehicle wheel.

Preferably, two or three axial locations for the correction planes can be determined. Two correction planes are located with axial distances on both sides of a central wheel plane. Further, dependent from the vehicle type (passenger car, motorcycle, light truck, heavy truck) suppression thresholds for acceptable residual static and dynamic (couple) imbalances are predetermined. After having conducted the measuring run for obtaining the imbalance data of the vehicle wheel, an electronical calculation system of the wheel balancer calculates a respective mass and a rotational angular position of a single correction weight in each of the predetermined axial locations of the correction planes on the associated radius of the wheel surface, particularly of the rim surface. Further, the electronical calculation system simulates the placement of the calculated mass in different rotational angular position including the calculated rotational angular position in each of the predetermined correction planes and compares the predetermined static and dynamic residual imbalances achieved during the simulated placement of each calculated correction mass in the associated correction plane. If the result of the simulation shows that the residual imbalances which are achieved at least in one of the predetermined correction planes are within the predetermined thresholds, a respective correction weight is placed in that correction plane on the wheel surface in the therefore calculated or simulated rotational angular position. If the residual imbalances are within the thresholds in each of the predetermined correction planes, that correction weight is placed in the associated correction plane for which the residual imbalances are the smallest.

Preferably, the single weight is placed, on one of the both sides of the central wheel plane, in that predetermined correction plane in which the measured imbalance is the highest. If the measured imbalance is higher in the correction plane on the left side of the central wheel plane, then the single weight is placed in said correction plane. If the measured imbalance is higher in the correction plane on the right side of the central wheel plane, the correction weight is placed in said correction plane.

During the simulation, the respectively calculated single weight is applied in each predetermined correction plane in different rotational angular positions in order to reach residual imbalances (static and dynamic) which are within the predetermined thresholds. In the event that at least one of the residual imbalances is beyond the predetermined threshold, the correction masses and angular positions of at least two correction weights to be placed in the two predetermined correction planes on the wheel surface are calculated according to the standard method in known manner.

The amount of the acceptable dynamic residual imbalance (dynamic threshold) has a double value of the amount of the acceptable static residual imbalance (static threshold), for example the acceptable dynamic residual imbalance is 5 grams and the acceptable static residual imbalance is 10 grams.

A further explanation of the invention will be given by the description of the Figures.

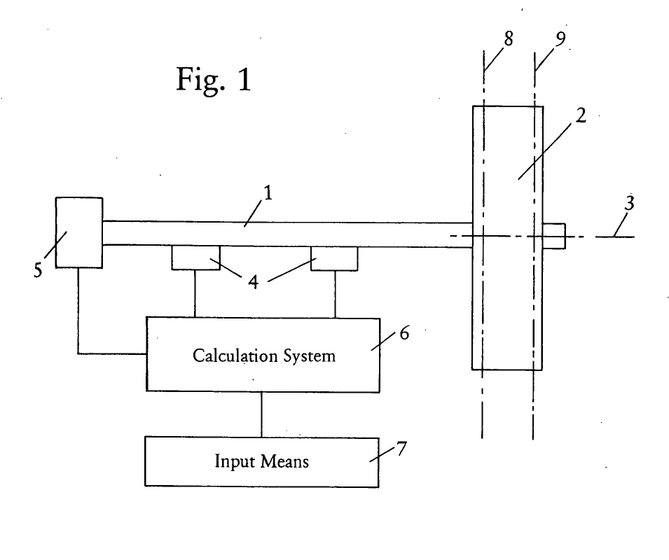

FIG. 1 shows schematically features of a wheel balancer which is an embodiment of the invention.

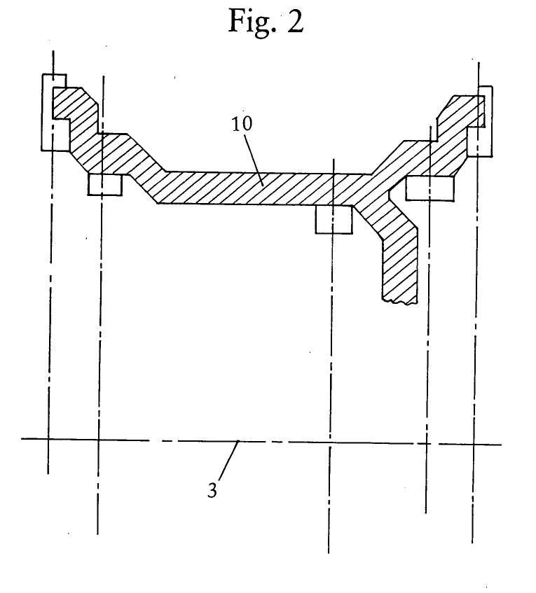

FIG. 2 shows schematically the profile of a wheel rim onto which correction weights can be placed in predetermined correction planes.

The shown embodiment includes a measurement shaft 1 on which a vehicle wheel 2 is mounted in known manner. In operative connection with the measurement shaft 1 are transducers of a measurement system 4 to obtain imbalance data resulting from an imbalance of the vehicle wheel 2. The transducers are configured to produce signals which are proportional to forces created by the wheel imbalance. The transducer signals are delivered to a calculation system 6 which may be the computing system of the wheel balancer or may be implemented into the computer system of the wheel balancer. The calculation system 6 is connected to a rotational angle determining system 5 and to input means 7.

The rotational angle determining system 5 provides a signal which is proportional to the rotational angle of the vehicle wheel 2 or of the measurement shaft 1 around a wheel axis 3 which can be coaxial with the shaft axis. The rotational angle determining system 5 can include a device which delivers a signal proportional to incremental rotational angles or another signal which is proportional to the rotational angles of the wheel starting from a zero point, for example a sinusoidal signal or a counting signal. The rotational angle determining system 5 may be implemented into the calculation system 6.

The input means 7 are configured to predetermine along the wheel axis 3 or shaft axis at least two axial locations of correction planes 8 and 9 within which at least one correction weight is to be placed for balancing the vehicle wheel 2. FIG. 2 shows several axial locations of correction planes which can be chosen on the surface of a rim 10 of the vehicle wheel 2. Further, the input means 7 are configured to predetermine dependent from the vehicle type thresholds for acceptable residual static and dynamic imbalances. The location data for the correction planes 8 and 9 may be input manually by the service person or may be input automatically by scanning the profile of the rim surface onto which the correction weights or the single correction weight should be placed. The values of the thresholds may be input manually.

The calculation system 6 is configured to calculate, using the imbalance data received from the measurement system 4, in each predetermined correction plane 8,9 the mass of a correction weight which compensates the imbalance acting in the respective predetermined correction plane 8 or 9 on the associated radius. As shown in FIG. 2, the inner and the outer rim edges or inner and outer rim surfaces facing the wheel axis 3 may be used as locations for the placement of the correction weights on the rim 10. As described above, at least two axial locations of respective correction planes 8,9 within which the single correction weight or more correction weights should be placed are predetermined. As shown in FIG. 2, dependent from the chosen correction planes, the radial locations of the weights may have the same radius or different radii.

The calculation system 6 is further designed to simulate the placement of each calculated mass in different rotational angular positions within the respective correction plane on the associated radius to find out the rotational angular position in which the residual static and dynamic imbalances are within the predetermined thresholds. If in one of the predetermined correction planes such a simulated position can be determined, a single correction weight is placed on the corresponding position onto the vehicle wheel, particularly onto the surface of the rim 10. If a simulated position of one of the calculated masses for compensating imbalance within the predetermined thresholds can not be found out during the simulation routine, the standard calculation in which static and dynamic balancing corrections are achieved with at least two correction weights is performed.

The described single weight modus may be a eligible modus of the wheel balancer. Additionally, the wheel balancer can perform the above described standard modus and other modi, for example a “behind the spokes” modus in which a placement of the correction weights behind the spokes is achieved, as disclosed in U.S. Pat. No. 5,591,909.

### FEATURE LIST

1 measurement shaft

2 vehicle wheel

3 wheel axis

4 measurement system

5 rotational angle determining system

6 calculating system

7 input means

8 correction plane

9 correction plane

10 rim of the vehicle wheel

1. A method for balancing a vehicle wheel, comprising:
predetermining, dependent from the type of the vehicle wheel, axial positions for positioning at least a single correction weight on the wheel surface,
predetermining, dependent from the vehicle type, thresholds for the residual static and dynamic imbalances;
obtaining imbalance data for the vehicle wheel during a measuring run;
calculating from the imbalance data the respective mass and angular position of a correction weight in each of the predetermined axial positions on the vehicle wheel;
comparing each of the predetermined static and dynamic residual imbalances with the achieved static and dynamic residual imbalances, when the calculated respective correction mass is placed by simulation in one of the axial positions in the different angular positions; and
placing the single correction weight with the calculated mass in the simulated angular position in that axial position in which the residual imbalances are within the predetermined thresholds.

2. The method according to claim 1, wherein in the event at least one of the residual imbalances achieved during the simulation is beyond the predetermined thresholds, the correction masses and angular positions of at least two correction weights to be fixed in two axial positions are calculated.

3. The method according to claim 1 or 2, wherein the single correction weight is placed in that predetermined axial position in which the measured imbalance is highest.

4. The method according to one of the claims 1 to 3, wherein the single correction weight is placed in a correction plane having an axial distance to the central plane of the wheel.

5. The method according to one of the claims 1 to 4, wherein the calculated mass of each corrective weight is placed during the simulation in different rotational angular positions in the associated predetermined correction plane on the respective radius of the wheel surface to find out an rotational angular position at which the residual imbalances are within the predetermined thresholds.

6. A wheel balancer comprising
a measurement shaft (1) on which a vehicle wheel (2) to be balanced can be mounted,
a measurement system (4) operatively connected with the measurement shaft (1) to obtain imbalance data resulting from an imbalance of the vehicle wheel (2),
a rotational angle determining system (5) for determining the rotational angle of the measurement shaft (1) or of the vehicle wheel (2);
a calculation system (6) to calculate from the imbalance data in each predetermined correction plane the mass of a correction weight compensating the imbalance acting in the respective correction plane,
input means (7) to predetermine along the wheel axis (3) the axial location of correction planes (8, 9) within which at least one correction weight is to be placed for balancing the vehicle wheel (2), and to predetermine, dependent from the vehicle type, thresholds for the residual static and dynamic imbalances,
wherein the calculation system (6) is configured to perform a simulation routine in which each calculated mass of the correction weight is placed in the respective correction plane (8, 9) in different rotational angular positions to find out the rotational angular position in which the residual imbalances are within the predetermined thresholds.

7. The wheel balance of claim 1, wherein the single weight modus performing the simulation routine is an eligible modus of the calculation system (6).
